(19) United States
(12) Patent Application Publication
(10) Pub. No.: US 2025/0008570 A1
(43) Pub. Date: Jan. 2, 2025

(54) TWO-STEP RANDOM ACCESS CHANNEL PROCEDURE

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/710,486

(22) PCT Filed: Jan. 28, 2022
(86) PCT No.: PCT/CN2022/074532

§ 371 Date: May 15, 2024

(51) Int. Cl. H04W 74/0836; H04B 7/06; H04B 17/318

(52) U.S. Cl. CPC H04W 74/0836; H04B 7/06968; H04B 17/328

(57) ABSTRACT

Various aspects of the present disclosure generally relate to wireless communication. In some aspects, a user equipment (UE) may transmit a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs. The UE may receive a message type-B (msgB) in the two-step RACH procedure, identifying a downlink beam associated with an SSB based at least in part on transmitting the msgA. The UE may transmit a response message, based at least in part on receiving the msgB, indicating a confirmation of an SSB index identified in the msgB or indicating a reversion to a different SSB index. Numerous other aspects are described.

### FIELD OF THE DISCLOSURE

Aspects of the present disclosure generally relate to wireless communication and to techniques and apparatuses for two-step random access channel procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs. The method may include receiving a message type-B (msgB) in the two-step RACH procedure, identifying a downlink beam associated with an SSB based at least in part on transmitting the msgA. The method may include transmitting a response message, based at least in part on receiving the msgB, indicating a confirmation of an SSB index identified in the msgB or indicating a reversion to a different SSB index.

Some aspects described herein relate to a method of wireless communication performed by a base station. The method may include receiving a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The method may include transmitting a msgB in the two-step RACH procedure, identifying a downlink beam associated with an SSB based at least in part on receiving the msgA. The method may include receiving a response message, based at least in part on transmitting the msgB, indicating a confirmation of an SSB index identified in the msgB or indicating a reversion to a different SSB index.

Some aspects described herein relate to a UE for wireless communication. The user equipment may include a memory and one or more processors coupled to the memory. The one or more processors may be configured to transmit a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The one or more processors may be configured to receive a msgB in the two-step RACH procedure, identifying a downlink beam associated with an SSB based at least in part on transmitting the msgA. The one or more processors may be configured to transmit a response message, based at least in part on receiving the msgB, indicating a confirmation of an SSB index identified in the msgB or indicating a reversion to a different SSB index.

Some aspects described herein relate to a base station for wireless communication. The base station may include a memory and one or more processors coupled to the memory. The one or more processors may be configured to receive a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The one or more processors may be configured to transmit a msgB in the two-step RACH procedure, identifying a downlink beam associated with an SSB based at least in part on receiving the msgA. The one or more processors may be configured to receive a response message, based at least in part on transmitting the msgB, indicating a confirmation of an SSB index identified in the msgB or indicating a reversion to a different SSB index.

Some aspects described herein relate to a non-transitory computer-readable medium that stores a set of instructions for wireless communication by a UE. The set of instructions, when executed by one or more processors of the UE, may cause the UE to transmit a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The set of instructions, when executed by one or more processors of the UE, may cause the UE to receive a msgB in the two-step RACH procedure, identifying a downlink beam associated with an SSB based at least in part on transmitting the msgA. The set of instructions, when executed by one or more processors of the UE, may cause the UE to transmit a response message, based at least in part on receiving the msgB, indicating a confirmation of an SSB index identified in the msgB or indicating a reversion to a different SSB index.

Some aspects described herein relate to a non-transitory computer-readable medium that stores a set of instructions for wireless communication by a base station. The set of instructions, when executed by one or more processors of the base station, may cause the base station to receive a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The set of instructions, when executed by one or more processors of the base station, may cause the base station to transmit a msgB in the two-step RACH procedure, identifying a downlink beam associated with an SSB based at least in part on receiving the msgA. The set of instructions, when executed by one or more processors of the base station, may cause the base station to receive a response message, based at least in part on transmitting the msgB, indicating a confirmation of an SSB index identified in the msgB or indicating a reversion to a different SSB index.

Some aspects described herein relate to an apparatus for wireless communication. The apparatus may include means for transmitting a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The apparatus may include means for receiving a msgB in the two-step RACH procedure, identifying a downlink beam associated with an SSB based at least in part on transmitting the msgA. The apparatus may include means for transmitting a response message, based at least in part on receiving the msgB, indicating a confirmation of an S SB index identified in the msgB or indicating a reversion to a different SSB index.

Some aspects described herein relate to an apparatus for wireless communication. The apparatus may include means for receiving a message type-A (msgA), of a two-step RACH procedure, identifying information associated with a plurality of SSBs, wherein the information includes at least one of a plurality of SSB indices associated with the plurality of SSBs or a plurality of RSRPs associated with the plurality of SSBs. The apparatus may include means for transmitting a msgB in the two-step RACH procedure, identifying a downlink beam associated with an SSB based at least in part on receiving the msgA. The apparatus may include means for receiving a response message, based at least in part on transmitting the msgB, indicating a confirmation of an S SB index identified in the msgB or indicating a reversion to a different SSB index.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of channel state information (CSI) reference signal (RS) (CSI-RS) beam management procedures, in accordance with the present disclosure.

FIG. 4 is a diagram illustrating an example of a two-step random access procedure, in accordance with the present disclosure.

FIG. 5 is a diagram illustrating an example associated with a two-step random access channel procedure for beam prediction, in accordance with the present disclosure.

FIGS. 6-7 are diagrams illustrating example processes associated with a two-step random access channel procedure for beam prediction, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

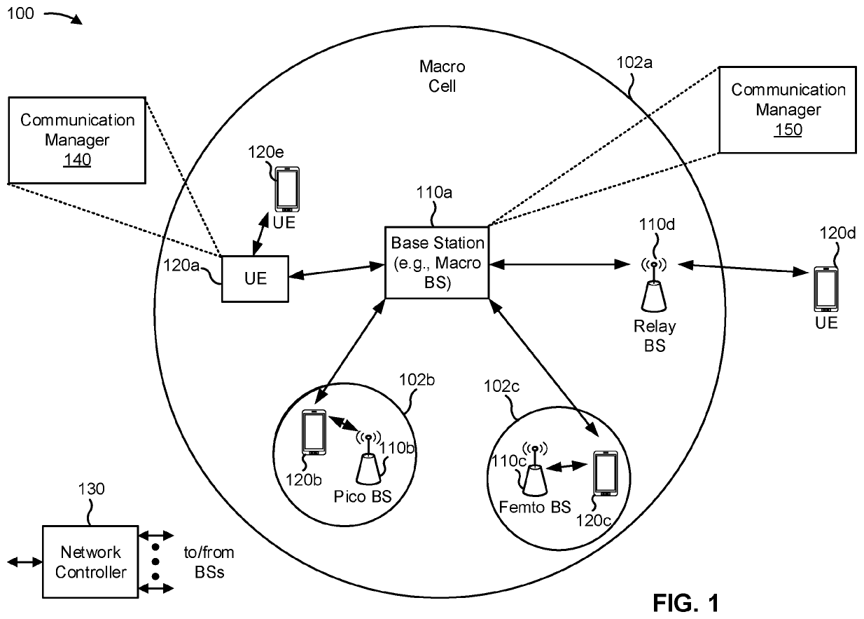

FIG. 1 is a diagram illustrating an example of a wireless network 100, in accordance with the present disclosure. The wireless network 100 may be or may include elements of a 5G (e.g., NR) network and/or a 4G (e.g., Long Tenn Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using abase station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHz-52.6 GHz). It should be understood that although a portion of FRI is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs; receive a message type-B (msgB) in the two-step RACH procedure, identifying a downlink beam associated with an SSB based at least in part on transmitting the msgA; and transmit a response message, based at least in part on receiving the msgB, indicating a confirmation of an S SB index identified in the msgB or indicating a reversion to a different SSB index. Additionally, or alternatively, the communication manager 140 may perform one or more other operations described herein.

In some aspects, the base station 110 may include a communication manager 150. As described in more detail elsewhere herein, the communication manager 150 may receive a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs; transmit a msgB in the two-step RACH procedure, identifying a downlink beam associated with an SSB based at least in part on receiving the msgA; and receive a response message, based at least in part on transmitting the msgB, indicating a confirmation of an SSB index identified in the msgB or indicating a reversion to a different SSB index. Additionally, or alternatively, the communication manager 150 may perform one or more other operations described herein.

As indicated above, FIG. 1 is provided as an example. Other examples may differ from what is described with regard to FIG. 1.

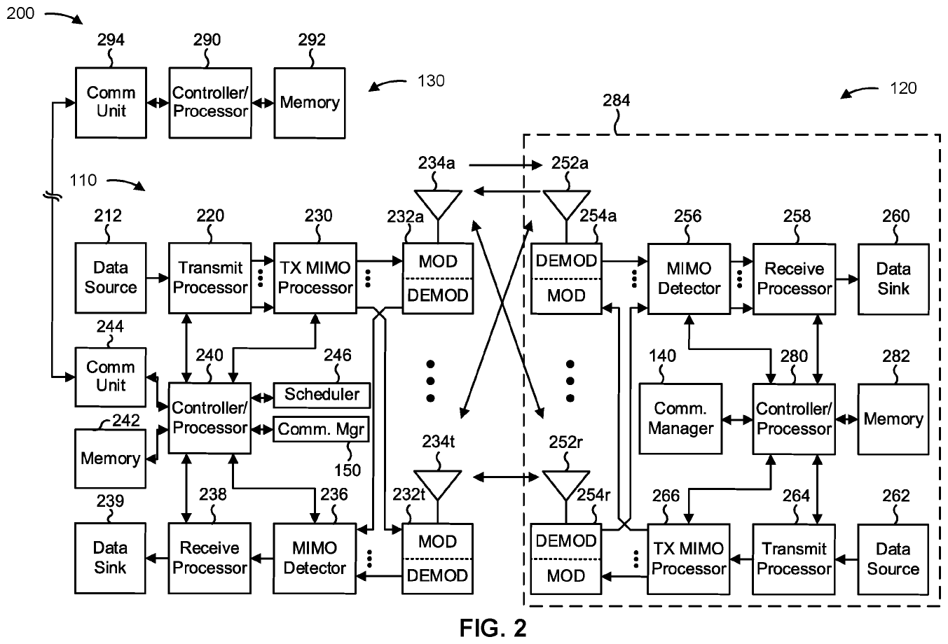

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

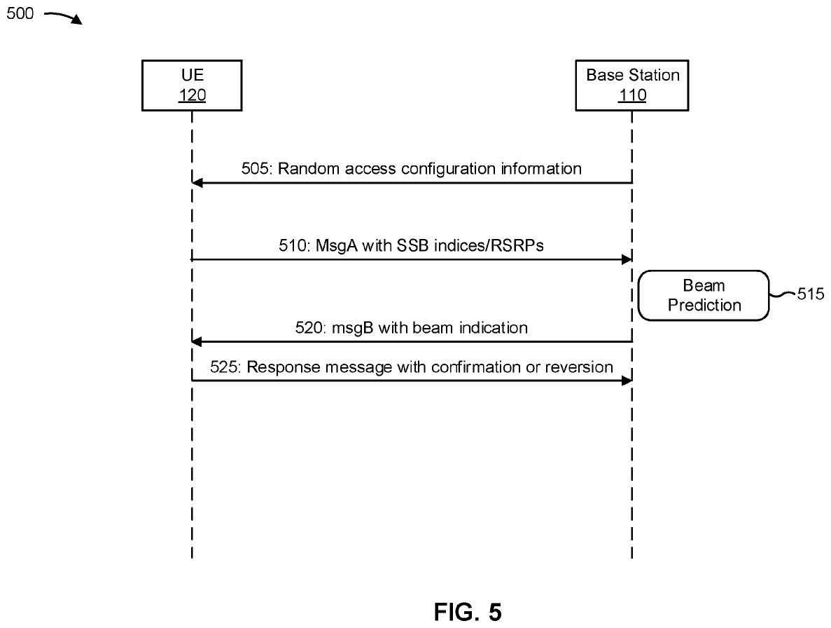

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

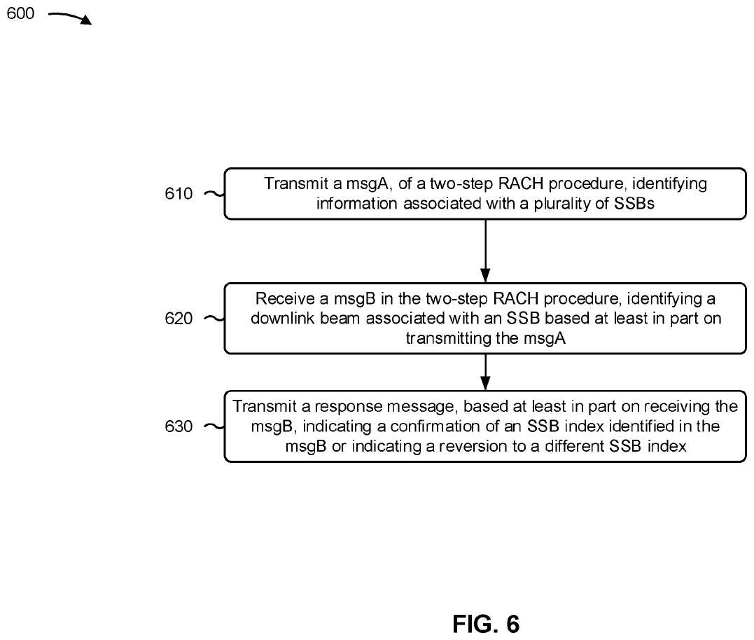

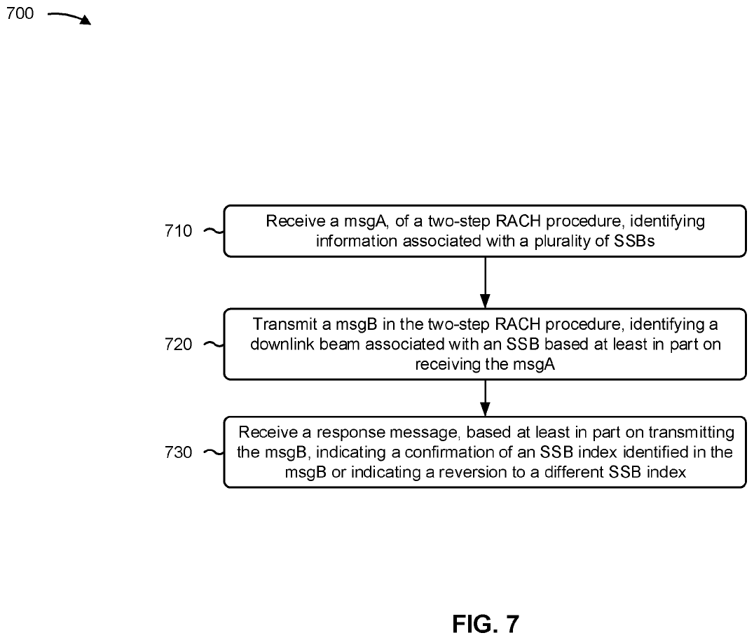

The controller/processor 240 of the base station 110, the controller/processor 280 of the UE 120, and/or any other component(s) of FIG. 2 may perform one or more techniques associated with a two-step RACH procedure for beam prediction, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication.

For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs; means for receiving a msgB in the two-step RACH procedure, identifying a downlink beam associated with an SSB based at least in part on transmitting the msgA; and/or means for transmitting a response message, based at least in part on receiving the msgB, indicating a confirmation of an SSB index identified in the msgB or indicating a reversion to a different SSB index. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs; means for transmitting a msgB in the two-step RACH procedure, identifying a downlink beam associated with an SSB based at least in part on receiving the msgA; and/or means for receiving a response message, based at least in part on transmitting the msgB, indicating a confirmation of an SSB index identified in the msgB or indicating a reversion to a different SSB index. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

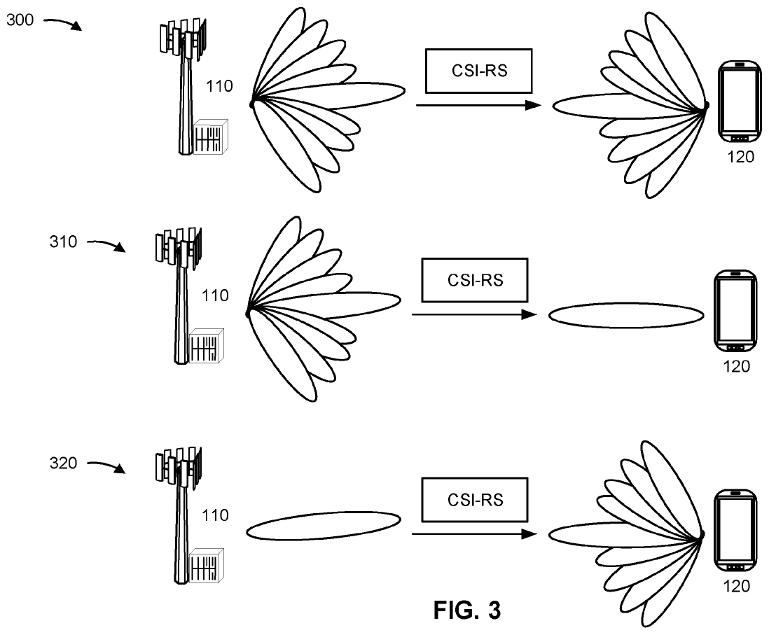

FIG. 3 is a diagram illustrating examples 300, 310, and 320 of channel state information (CSI) reference signal (RS) (CSI-RS) beam management procedures, in accordance with the present disclosure. As shown in FIG. 3, examples 300, 310, and 320 include a UE 120 in communication with abase station 110 in a wireless network (e.g., wireless network 100).

However, the devices shown in FIG. 3 are provided as examples, and the wireless network may support communication and beam management between other devices (e.g., between a UE 120 and a base station 110 or TRP, between a mobile termination node and a control node, between an integrated access and backhaul (IAB) child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic CSI-RSs (P-CSI-RSs) (e.g., using RRC signaling), semi-persistent (SP) CSI-RSs (SP-CSI-RSs) (e.g., using media access control (MAC) control element (CE) (MAC-CE) signaling), and/or aperiodic (AP) CSI-RSs (AP-CSI-RSs) (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station 110 may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120.

As a result, the first beam management procedure may enable the UE 120 to measure a CSI-RS on different transmit beams using different receive beams to support selection of base station 110 transmit beam(s)/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use SSBs for beam management in a similar manner as described above. For example, UE 120 and base station 110 may perform SSB beam sweeping (e.g., during initial access along with SSB and RACH association) to select a beam pair with a course granularity (e.g., by using wider, layer 1 (L1) beams) before performing CSI-RS beam sweeping (e.g., in a connected mode) to select a beam pair with a finer granularity (e.g., using hierarchical beam refinement, as described herein).

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a hierarchical beam refinement procedure (e.g., a P1, P2, or P3 procedure, as described herein), a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams). In some cases, beam failure recovery procedures may be used to recover a beam after a detected beam failure or radio link failure procedures may be used to identify a new beam after a detected beam or radio link failure.

In some cases, UE 120 and base station 110 may use beam prediction to reduce a quantity of beam measurements associated with selecting a beam (e.g., in one or more of the aforementioned beam management procedures). For example, when beam prediction is not used, UE 120 and base station 110 may communicate (e.g., by transmitting a CSI-RS and performing measurements and by reporting the measurements) on each beam across a beam sweep. However, when, for example, base station 110 performs a beam prediction procedure, base station 110 and UE 120 may forgo transmission or measurement of one or more beams of the beam sweep. For example, for a set of consecutive beams (e.g., consecutive with regard to beam angle) that are configured for base station 110, base station 110 may forgo transmission of one or more beams within the set of consecutive beams. In this case, base station 110 may completely forgo one or more beam transmissions or may selectively transmit one or more beams (e.g., sometimes forgo one or more beam transmissions) based at least in part on whether UE 120 is performing initial access or not, based at least in part on how recently the one or more beams were transmitted, or based at least in part on a configured periodicity, among other examples. Additionally, or alternatively, base station 110 may transmit all of the beams in the set of consecutive beams, but UE 120 may forgo measurement and/or reporting of one or more beams within the set of consecutive beams. In these cases, base station 110 and/or UE 120 may interpolate (e.g., using artificial intelligence or another prediction technique) from measured beams to predict beam measurements (e.g., an RSRP) for one or more beams that have not been transmitted and/or measured. For example, UE 120 may predict a beam measurement of a beam, which UE 120 has selected to forgo measuring, based at least in part on one or more other beam measurements and may report the predicted beam measurement to base station 110. Additionally, or alternatively, UE 120 may forgo reporting a beam measurement for the beam, which UE 120 has selected to forgo measuring, and base station 110 may predict a beam measurement for the beam. In this case, base station 110 may use the predicted beam measurement with actual beam measurements to configure communications, as described herein.

Similarly, base station 110 and/or UE 120 may forgo transmission and measurement of beams with a higher granularity. For example, rather than a first beam management procedure using wide beams and a second beam management procedure using narrow beams, base station 110 may forgo transmission and/or UE 120 may forgo measurement of the narrow beams. In this case, base station 110 and/or UE 120 may predict beam measurements for the narrow beams (e.g., that have not been transmitted and/or measured) based at least in part on beam measurements of the wide beams (e.g., that have been transmitted and measured) and/or based at least in part on past beam predictions or measurements. In these ways, base station 110 and/or UE 120 reduce a quantity of UE-side beam measurements and/or a UE-specific communication overhead, thereby improving UE performance and/or network performance.

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

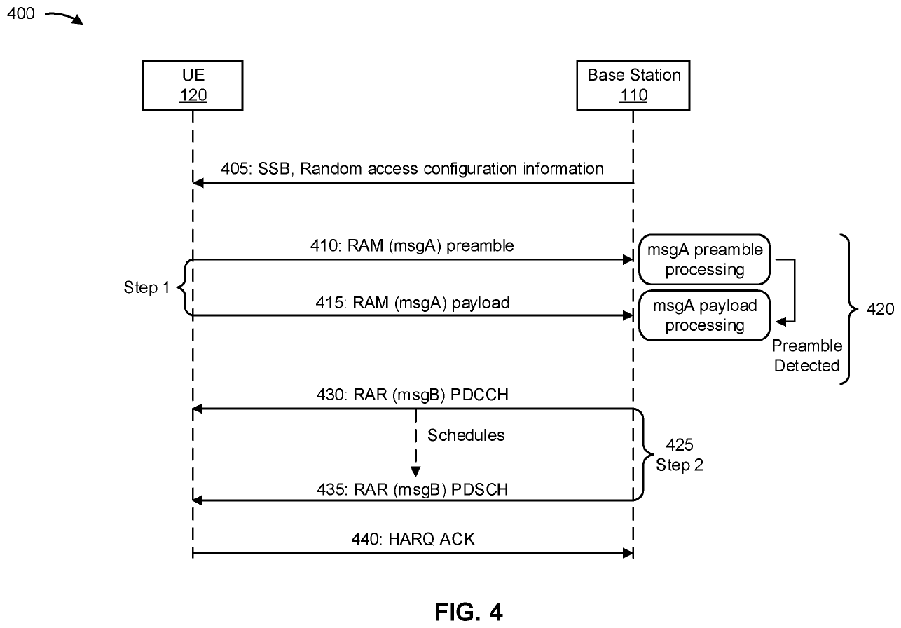

FIG. 4 is a diagram illustrating an example 400 of a two-step random access procedure, in accordance with the present disclosure. As shown in FIG. 4, a base station 110 and a UE 120 may communicate with one another to perform the two-step random access procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a RRC message and/or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 410, the UE 120 may transmit, and the base station 110 may receive, a RAM preamble. As shown by reference number 415, the UE 120 may transmit, and the base station 110 may receive, a RAM payload. As shown, the UE 120 may transmit the RAM preamble and the RAM payload to the base station 110 as part of an initial (or first) step of the two-step random access (or “random access channel”) (RACH) procedure. In some aspects, the RAM may be referred to as message A or message type-A (msgA), a first message, or an initial message in a two-step RACH procedure. Furthermore, in some aspects, the RAM preamble may be referred to as a message A preamble, a message type-A preamble, a msgA preamble, a preamble, or a physical random access channel (PRACH) preamble, and the RAM payload may be referred to as a message A payload, a message-A payload, a msgA payload, or a payload. In some aspects, the RAM may include some or all of the contents of message 1 (msg1) and message 3 (msg3) of a four-step RACH procedure. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

As shown by reference number 420, the base station 110 may receive the RAM preamble transmitted by the UE 120. If the base station 110 successfully receives and decodes the RAM preamble, the base station 110 may then receive and decode the RAM payload.

As shown by reference number 425, the base station 110 may transmit an RAR (sometimes referred to as an RAR message). As shown, the base station 110 may transmit the RAR message as part of a second step of the two-step RACH procedure. In some aspects, the RAR message may be referred to as message B, message type-B, msgB, or a second message in a two-step RACH procedure. The RAR message may include some or all of the contents of message 2 (msg2) and message 4 (msg4) of a four-step RACH procedure. For example, the RAR message may include the detected PRACH preamble identifier, the detected UE identifier, a timing advance value, and/or contention resolution information.

As shown by reference number 430, as part of the second step of the two-step RACH procedure, the base station 110 may transmit a PDCCH communication for the RAR. The PDCCH communication may schedule a physical downlink shared channel (PDSCH) communication that includes the RAR. For example, the PDCCH communication may indicate a resource allocation (e.g., in DCI) for the PDSCH communication.

As shown by reference number 435, as part of the second step of the two-step RACH procedure, the base station 110 may transmit the PD SCH communication for the RAR, as scheduled by the PDCCH communication. The RAR may be included in a MAC protocol data unit (PDU) of the PDSCH communication. As shown by reference number 440, if the UE 120 successfully receives the RAR, the UE 120 may transmit a hybrid automatic repeat request (HARQ) acknowledgement (ACK).

As indicated above, FIG. 4 is provided as an example. Other examples may differ from what is described with regard to FIG. 4.

As described above, during a two-step RACH procedure, a UE may report a UE identifier, UCI, and/or PUSCH transmission information regarding a measurement of a beam. For example, the UE may report a single SSB index for an associated RACH occasion (RO) using a RACH preamble of msgA of a two-step RACH procedure. However, to perform beam prediction, abase station may use information regarding a plurality of SSBs or other reference signals. As a result, the UE may use a plurality of ROs to indicate a plurality of SSB indices. Additionally, or alternatively, the base station may use measurement information (e.g., RSRPs for each of the SSBs) to perform beam prediction. Conveying the measurement information via a plurality of transmissions may result in an excess utilization of network resources.

Further, before RRC connection setup occurs, a base station may use a transmission configuration indicator (TCI)-state update (e.g., configured via RRC signaling) and a TCI state activation (e.g., using a MAC-CE) in connection with DCI indicating an activated TCI state codepoint. However, using a TCI state update, TCI state activation, and/or a TCI state codepoint to indicate a beam may restrict base station flexibility to dynamically indicate a new downlink beam before an RRC connection setup occurs, which may result in a UE using a sub-optimal beam, thereby causing communication interruptions.

Some aspects described herein may provide a two-step RACH procedure to support beam prediction. For example, a UE may report, to a base station and using a two-step RACH procedure msgA, a plurality of SSB indices for a plurality of measured SSBs and/or a plurality of associated RSRPs for the plurality of measured SSBs. In this way, the UE enables reporting of beam information to the base station for beam prediction using a single RO, thereby reducing a utilization of communication resources relative to other two-step RACH procedure messages. The base station may select a beam (e.g., using beam prediction) for use by the UE and may transmit a two-step RACH procedure msgB to indicate the selected beam to the UE. Based at least in part on receiving the msgB, the UE may transmit a response message to confirm the selected beam or indicate a reversion to a previously selected beam. In this way, the base station and the UE enable dynamic beam indication before RRC connection setup, thereby reducing a likelihood of communication interruptions associated with using a sub-optimal beam.

FIG. 5 is a diagram illustrating an example 500 associated with a two-step RACH procedure for beam prediction, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As further shown in FIG. 5, and by reference number 505, the UE 120 may receive RACH configuration information. For example, the base station 110 may configure the UE 120 for a RACH procedure. In some aspects, the base station 110 may transmit configuration information via a system information (SI) or SIB (e.g., SIB type 1 (SIB1)) transmission. For example, the UE 120 may be configured by SIB1 with information identifying RACH procedures for reduced beam measurement. In this case, the UE 120 may determine that msgA preamble resources do not cover all SSB indices (e.g., all SSBs corresponding to all beams with which the UE 120 is configured). Alternatively, the UE 120 may determine that msgA preamble resources do cover all SSB indices. Alternatively, the UE 120 may determine that, collectively, a msgA preamble and a msgA payload (e.g., a msgA-PUSCH) do not cover all SSB indices. Alternatively, the UE 120 may determine that, collectively, the msgA preamble and the msgA payload do cover all SSB indices. In some aspects, the UE 120 may receive, configuration information indicating a format of SIB1. For example, the UE 120 may receive configuration information indicating whether SIB1 will identify msgA-preamble resources covering or not covering all SSB indices or msgA-preamble and msgA-payload resources covering or not covering all SSB indices. In this case, the base station 110 may include the configuration information for use in interpreting the SIB1 in the SIB1 or in a separate RACH configuration message. Additionally, or alternatively, the UE 120 may receive a SIB1 or system information associated with configuring a cell-common CSI report configuration (CSI-ReportConfig) with a report quantity (reportQuantity) set to a particular value (ssb-Index-RSRP) for reporting SSB indices and RSRPs, as described herein.

As further shown in FIG. 5, and by reference number 510, the UE 120 may transmit a msgA with a plurality of SSB indices and/or a plurality of identified RSRPs. For example, based at least in part on measuring a plurality of SSBs, the UE 120 may transmit the msgA to identify SSB indices of the plurality of SSBs (and associated beams) and/or measured RSRPs of the plurality of SSBs. Although some aspects are described herein in terms of SSBs other reference signals (e.g., CSI-RSs) may be possible. Additionally, or alternatively, the UE 120 may use a cell-common CSI report configuration with a report quantity set to report SSB indices and/or associated RSRPs.

In some aspects, the UE 120 may report the plurality of SSB indices using preamble portioning or on a per-RO basis. For example, the UE 120 may transmit a preamble (e.g., a msgA preamble) associated with a first RO that includes information identifying a first plurality of SSBs and a preamble associated with a second RO that includes information identifying a second plurality of SSBs. In this case, an ordering of each plurality of SSBs identified within a respective preamble may correspond to an ordering of RSRPs (or another signal strength metric). In some aspects, the UE 120 may convey information identifying SSB indices with a first one or more strongest RSRPs in the preamble based at least in part on a static configuration in a standard or specification.

In some aspects, the UE 120 may use a sequential order of SSB indices to indicate a relative order of RSRPs. For example, the UE 120 may transmit a set of preambles associated with a single RO, where an order of preambles corresponds to a relative RSRP of an SSB. In other words, a first preamble may identify a first SSB with a strongest RSRP, a second preamble may identify a second SSB with a second strongest RSRP, and a third SSB may identify a third SSB with a third strongest RSRP. Additionally, or alternatively, the UE 120 may transmit a first preamble associated with a first RO set including a first SSB associated with a strongest RSRP, a second preamble associated with a second RO set including a second SSB with a second strongest RSRP, and a third preamble associated with a third RO set including a third SSB with a third strongest RSRP. In these cases, an association between ROs and SSB indices is based at least in part on the sequential order of preambles.

In some aspects, the UE 120 may report SSB indices using a first portion of msgA and RSRPs using a second portion of msgA. For example, the UE 120 may report SSB indices using a preamble of msgA and RSRPs using a payload (e.g., PUSCH) of msgA. Additionally, or alternatively, the UE 120 may report one or more SSB indices and RSRPs using the same portion of msgA. For example, the UE 120 may report a first SSB index and/or a first RSRP for a first SSB with a strongest RSRP in a preamble of msgA and may report one or more second SSB indices and/or one or more second RSRPs for one or more second SSBs with weaker RSRPs (than the first SSB) in a payload of msgA.

As further shown in FIG. 5, and by reference number 515, the base station 110 may perform a beam prediction procedure. For example, as described herein, the base station 110 may select a beam for the UE 120 to use for communication based at least in part on a beam prediction procedure. In this case, the base station 110 may use reported SSB indices and/or RSRPs for one or more beams to predict RSRPs (or other parameters) for one or more other beams (e.g., for which measurements were not performed and/or reported). In this case, the base station 110 may select a beam based at least in part on a measurement or predicted measurement.

As further shown in FIG. 5, and by reference numbers 520 and 525, the UE 120 may receive a msgB with a beam indication and may transmit a response message including a confirmation of a selected beam in the beam indication or a request for a reversion to a different (previous) beam. For example, the UE 120 may receive, from the base station 110, information identifying a selected beam for use by the UE 120. In some aspects, the base station 110 may include an SSB index update (e.g., indicating a beam that the UE 120 is to use) in a portion of msgB. For example, the base station 110 may use a msgB PDSCH to convey an SSB index update. Additionally, or alternatively, the base station 110 may provide the SSB index update in a RAR uplink grant MAC-PDU, which may include a field for conveying information identifying one or more selected SSB indices (e.g., that were included in the msgA). For example, the msgB PDSCH may convey the RAR UL grant MAC-PDU with at least one SSB index (e.g., that is the same or different from SSB indices reported in the msgA).

In some aspects, the UE 120 may determine an indicated SSB index based at least in part on a random access (RA) radio network temporary identifier (RNTI) (RA-RNTI) and/or a format of a MAC-PDU. For example, the UE 120 may receive a RAR uplink grant MAC-PDU with a particular format and a RA-RNTI associated with a RACH resource of the msgA, which may indicate usage of an SSB index reported in the msgA. Additionally, or alternatively, the UE 120 may receive a RAR uplink grant MAC-PDU with a particular format and an RA-RNTI associated with a reported SSB index of the msgA to indicate usage of an SSB index of the msgA. Additionally, or alternatively, the UE 120 may receive a RAR uplink grant MAC-PDU with a particular format with a bit indicator (e.g., a CSI-RS request bit indicator). In this case, the RAR may be associated with an RA-RNTI corresponding to a RACH resource or corresponding to a reported SSB index of msgA. In other words, if the bit indicator is ‘0’, the indicated SSB index is the same as the msgA-reported SSB index with a strongest RSRP, but if the bit indicator is ‘1’, the indicated SSB index is different from the msgA-reported SSB index with a strongest RSRP and the UE 120 is to reinterpret the MAC-PDU payload to determine which SSB index to use for communication.

In some aspects, the UE 120 may determine a quasi-co-location (QCL) parameter based at least in part on the msgB. For example, when the UE 120 receives information identifying an SSB index that is the same as a UE reported SSB index with a highest RSRP, the UE 120 may maintain the same downlink QCL assumption (e.g., for an SSB associated with the SSB index) as was previously being used. Alternatively, the UE 120 may switch from a first downlink QCL assumption previously being used for the identified SSB index to a second downlink QCL assumption of another SSB index. In this case, the UE 120 may report the second downlink QCL assumption in a subsequent uplink message, such as the response message.

Additionally, or alternatively, when the UE 120 receives information identifying an SSB index that is different from a UE reported SSB index with a highest RSRP, the UE 120 switch from using a first QCL assumption associated with the msgA-reported SSB index to using a second QCL assumption associated with the msgB-identified SSB index. Alternatively, the UE 120 may remain using the first QCL assumption associated with the msgA-reported SSB index and may transmit information reporting usage of the first QCL assumption in a subsequent uplink message, such as the response message.

In some aspects, the UE 120 may transmit a response message including a request for a reversion. For example, when the base station 110 transmits a msgB indicating a first SSB index associated with a first SSB (e.g., a first beam) that the UE 120 is to use for communication, the UE 120 may transmit a response message identifying a second SSB index associated with a second SSB (e.g., a second beam) that the UE 120 would prefer to use. In this case, the UE 120 may transmit the response message using a msg3 of a four-step RACH procedure or another pre-RRC connection setup uplink message. When reverting to a different beam (e.g., a prior-selected beam) than the base station 110 indicated, the UE 120 may use a downlink QCL assumption for receiving subsequent downlink messages after transmitting the feedback message to identify the second SSB index. Similarly, the UE 120 may use an uplink QCL assumption corresponding to the downlink QCL assumption after transmitting the response message to identify the second SSB index.

In some aspects, the UE 120 may be constrained in which SSB indices (e.g., and corresponding beams) the UE 120 can select for a reversion. For example, the UE 120 may be constrained to only select an SSB index reported in msgA with a highest RSRP. In this way, the UE 120 may avoid excess blind detection by the base station 110 and/or issues with the base station 110 performing digital receive beamforming.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with two-step random access channel procedure for beam prediction.

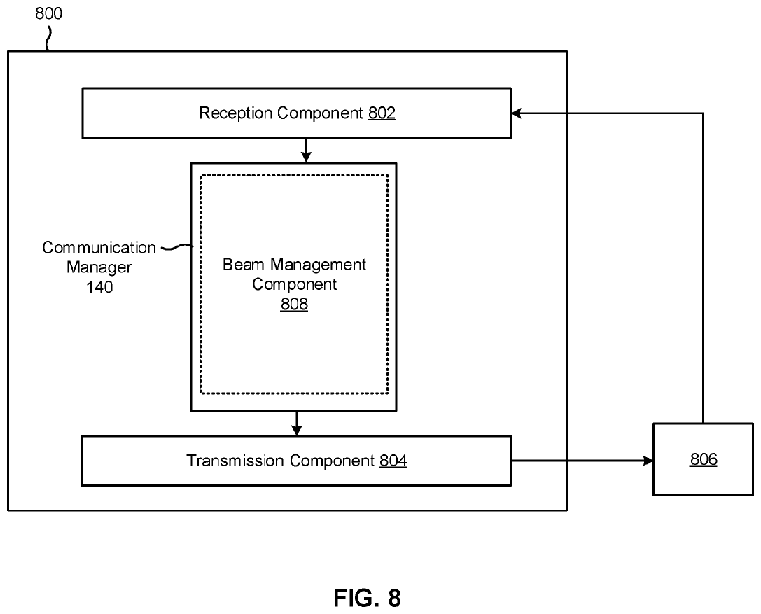

As shown in FIG. 6, in some aspects, process 600 may include transmitting a msgA, of a two-step RACH procedure, identifying information associated with a plurality of SSBs (block 610). For example, the UE (e.g., using communication manager 140 and/or transmission component 804, depicted in FIG. 8) may transmit a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs, as described above.

As further shown in FIG. 6, in some aspects, process 600 may include receiving a msgB in the two-step RACH procedure, identifying a downlink beam associated with an SSB based at least in part on transmitting the msgA (block 620). For example, the UE (e.g., using communication manager 140 and/or reception component 802, depicted in FIG. 8) may receive a msgB in the two-step RACH procedure, identifying a downlink beam associated with an SSB based at least in part on transmitting the msgA, as described above.

As further shown in FIG. 6, in some aspects, process 600 may include transmitting a response message, based at least in part on receiving the msgB, indicating a confirmation of an SSB index identified in the msgB or indicating a reversion to a different SSB index (block 630). For example, the UE (e.g., using communication manager 140 and/or transmission component 804, depicted in FIG. 8) may transmit a response message, based at least in part on receiving the msgB, indicating a confirmation of an SSB index identified in the msgB or indicating a reversion to a different SSB index, as described above.

Process 600 may include additional aspects, such as any single aspect or any combination of aspects described below and/or in connection with one or more other processes described elsewhere herein.

In a first aspect, the msgA includes one or more fields for reporting the plurality of SSB indices.

In a second aspect, alone or in combination with the first aspect, the msgA is based at least in part on a random access channel occasion or a random access channel preamble partitioning.

In a third aspect, alone or in combination with one or more of the first and second aspects, the msgA includes a preamble conveying information identifying the plurality of SSB indices, and wherein the msgA includes a shared channel message portion identifying the plurality of RSRPs.

In a fourth aspect, alone or in combination with one or more of the first through third aspects, the msgA includes a preamble conveying information identifying an SSB index, of the plurality of SSB indices, having a strongest RSRP of the plurality of RSRPs, and wherein the msgA includes a shared channel message portion identifying one or more additional SSB indices, of the plurality of SSB indices, or one or more additional RSRPs, of the plurality of RSRPs.

In a fifth aspect, alone or in combination with one or more of the first through fourth aspects, the UE is configured to determine a transmit beam based at least in part on an SSB index, of the plurality of SSB indices, with a strongest RSRP of the plurality of RSRPs.

In a sixth aspect, alone or in combination with one or more of the first through fifth aspects, the msgB includes a field for receiving an SSB index included in the plurality of SSB indices of the msgA or an SSB index not included in the plurality of SSB indices of the msgA.

In a seventh aspect, alone or in combination with one or more of the first through sixth aspects, a downlink QCL parameter is based at least in part on at least one of a value of the SSB index of the field of the msgB or whether the SSB index is included in the plurality of SSB indices of the msgA or not included in the plurality of SSB indices of the msgA.

In an eighth aspect, alone or in combination with one or more of the first through seventh aspects, a downlink QCL parameter is based at least in part on a random access response uplink grant medium access control protocol data unit format.

In a ninth aspect, alone or in combination with one or more of the first through eighth aspects, a downlink QCL parameter is based at least in part on a random access radio network temporary identifier associated with the msgA.

In a tenth aspect, alone or in combination with one or more of the first through ninth aspects, the response message includes at least one of a first SSB index that is different from a second SSB index included in the msgB, or an RSRP value for the first SSB index.

In an eleventh aspect, alone or in combination with one or morn of the first through tenth aspects, the UE is configured to use a downlink or uplink quasi-co-location parameter associated with an SSB index included in the response message.

In a twelfth aspect, alone or in combination with one or more of the first through eleventh aspects, the response message is constrained to include an SSB index, that is different from another SSB index of the msgB, with a strongest RSRP of the plurality of RSRPs.

In a thirteenth aspect, alone or in combination with one or more of the first through twelfth aspects, process 600 includes receiving a system information block including random access channel configuration information, wherein the random access channel configuration information identifies at least one of preamble resources for a subset of SSB indices of a set of configured SSB indices, preamble resources for the set of configured SSB indices, preamble and shared channel resources for the subset of SSB indices, or preamble and shared channel resources for the set of configured SSB indices.

In a fourteenth aspect, alone or in combination with one or more of the first through thirteenth aspects, the UE is configured to include information relating to the plurality of SSB indices or the plurality of RSRPs in a channel state information report configuration with a report quantity.

In a fifteenth aspect, alone or in combination with one or more of the first through fourteenth aspects, the UE is configured based at least in part on a system information block, system information, or a static configuration.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with two-step random access channel procedure for beam prediction.

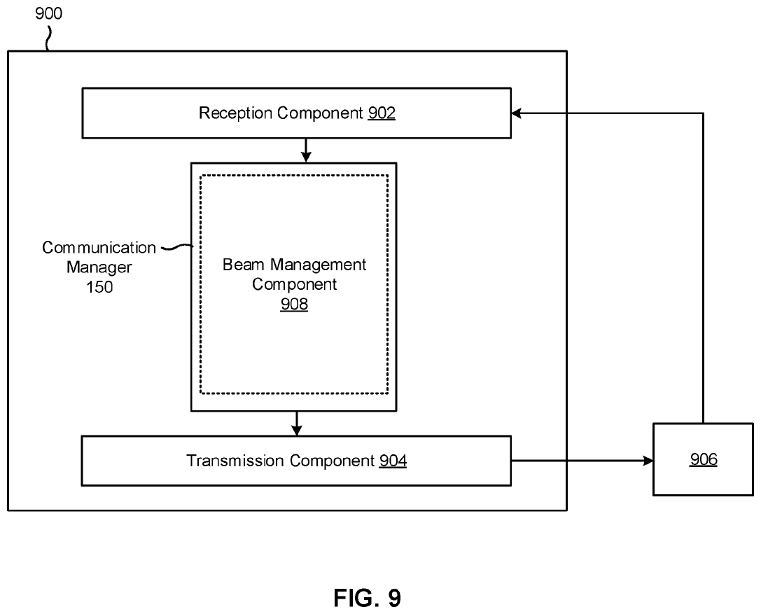

As shown in FIG. 7, in some aspects, process 700 may include receiving a msgA, of a two-step RACH procedure, identifying information associated with a plurality of SSBs (block 710). For example, the base station (e.g., using communication manager 150 and/or reception component 902, depicted in FIG. 9) may receive a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs, as described above.

As further shown in FIG. 7, in some aspects, process 700 may include transmitting a msgB in the two-step RACH procedure, identifying a downlink beam associated with an SSB based at least in part on receiving the msgA (block 720). For example, the base station (e.g., using communication manager 150 and/or transmission component 904, depicted in FIG. 9) may transmit a msgB in the two-step RACH procedure, identifying a downlink beam associated with an SSB based at least in part on receiving the msgA, as described above.

As further shown in FIG. 7, in some aspects, process 700 may include receiving a response message, based at least in part on transmitting the msgB, indicating a confirmation of an SSB index identified in the msgB or indicating a reversion to a different SSB index (block 730). For example, the base station (e.g., using communication manager 150 and/or reception component 902, depicted in FIG. 9) may receive a response message, based at least in part on transmitting the msgB, indicating a confirmation of an SSB index identified in the msgB or indicating a reversion to a different SSB index, as described above.

Process 700 may include additional aspects, such as any single aspect or any combination of aspects described below and/or in connection with one or more other processes described elsewhere herein.

In a first aspect, the msgA includes one or more fields for reporting the plurality of SSB indices.

In a second aspect, alone or in combination with the first aspect, the msgA is based at least in part on a random access channel occasion or a random access channel preamble partitioning.

In a third aspect, alone or in combination with one or more of the first and second aspects, the msgA includes a preamble conveying information identifying the plurality of SSB indices, and wherein the msgA includes a shared channel message portion identifying the plurality of RSRPs.

In a fourth aspect, alone or in combination with one or more of the first through third aspects, the msgA includes a preamble conveying information identifying an SSB index, of the plurality of SSB indices, having a strongest RSRP of the plurality of RSRPs, and wherein the msgA includes a shared channel message portion identifying one or more additional SSB indices, of the plurality of SSB indices, or one or more additional RSRPs, of the plurality of RSRPs.

In a fifth aspect, alone or in combination with one or more of the first through fourth aspects, a transmit beam is based at least in part on an SSB index, of the plurality of SSB indices, with a strongest RSRP of the plurality of RSRPs.

In a sixth aspect, alone or in combination with one or more of the first through fifth aspects, the msgB includes a field for receiving an SSB index included in the plurality of SSB indices of the msgA or an SSB index not included in the plurality of SSB indices of the msgA.

In a seventh aspect, alone or in combination with one or more of the first through sixth aspects, a downlink QCL parameter is based at least in part on at least one of a value of the SSB index of the field of the msgB or whether the SSB index is included in the plurality of SSB indices of the msgA or not included in the plurality of SSB indices of the msgA.

In an eighth aspect, alone or in combination with one or more of the first through seventh aspects, a downlink QCL parameter is based at least in part on a random access response uplink grant medium access control protocol data unit format.

In a ninth aspect, alone or in combination with one or more of the first through eighth aspects, a downlink QCL parameter is based at least in part on a random access radio network temporary identifier associated with the msgA.

In a tenth aspect, alone or in combination with one or more of the first through ninth aspects, the response message includes at least one of a first SSB index that is different from a second SSB index included in the msgB, or an RSRP value for the first SSB index.

In an eleventh aspect, alone or in combination with one or more of the first through tenth aspects, the response message includes a downlink or uplink quasi-co-location parameter associated with an SSB index.

In a twelfth aspect, alone or in combination with one or more of the first through eleventh aspects, the response message is constrained to include an SSB index, that is different from another SSB index of the msgB, with a strongest RSRP of the plurality of RSRPs.

In a thirteenth aspect, alone or in combination with one or more of the first through twelfth aspects, process 700 includes transmitting a system information block including random access channel configuration information, wherein the random access channel configuration information identifies at least one of preamble resources for a subset of SSB indices of a set of configured SSB indices, preamble resources for the set of configured SSB indices, preamble and shared channel resources for the subset of SSB indices, or preamble and shared channel resources for the set of configured SSB indices.

In a fourteenth aspect, alone or in combination with one or more of the first through thirteenth aspects, information relating to the plurality of SSB indices or the plurality of RSRPs is included in a channel state information report configuration with a report quantity.

In a fifteenth aspect, alone or in combination with one or more of the first through fourteenth aspects, the base station is configured to configure a user equipment using a system information block or system information.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a beam management component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The transmission component 804 may transmit a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The reception component 802 may receive a msgB in the two-step RACH procedure, identifying a downlink beam associated with an SSB based at least in part on transmitting the msgA. The transmission component 804 may transmit a response message, based at least in part on receiving the msgB, indicating a confirmation of an S SB index identified in the msgB or indicating a reversion to a different SSB index. The beam management component 808 may determine one or more measurements of a beam for a RACH procedure and/or may select a beam to use based at least in part on a result of the RACH procedure.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a beam management component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The reception component 902 may receive a msgA, of a two-step RACH procedure, identifying information associated with a plurality of SSBs, wherein the information includes at least one of a plurality of SSB indices associated with the plurality of SSBs or a plurality of RSRPs associated with the plurality of SSBs. The transmission component 904 may transmit a msgB in the two-step RACH procedure, identifying a downlink beam associated with an SSB based at least in part on receiving the msgA. The reception component 902 may receive a response message, based at least in part on transmitting the msgB, indicating a confirmation of an SSB index identified in the msgB or indicating a reversion to a different SSB index.

The transmission component 904 may transmit a system information block including random access channel configuration information, wherein the random access channel configuration information identifies at least one of preamble resources for a subset of SSB indices of a set of configured SSB indices, preamble resources for the set of configured SSB indices, preamble and shared channel resources for the subset of SSB indices, or preamble and shared channel resources for the set of configured SSB indices. The beam management component 908 may determine a beam for usage based at least in part on reported beam indices received during a two-step RACH procedure.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components.

Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: transmitting a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs; receiving a message type-B (msgB) in the two-step RACH procedure, identifying a downlink beam associated with an SSB based at least in part on transmitting the msgA; and transmitting a response message, based at least in part on receiving the msgB, indicating a confirmation of an SSB index identified in the msgB or indicating a reversion to a different SSB index.
Aspect 2: The method of Aspect 1, wherein the msgA includes one or more fields for reporting the plurality of SSB indices.
Aspect 3: The method of any of Aspects 1 to 2, wherein the msgA is based at least in part on a random access channel occasion or a random access channel preamble partitioning.
Aspect 4: The method of any of Aspects 1 to 3, wherein the msgA includes a preamble conveying information identifying the plurality of SSB indices, and wherein the msgA includes a shared channel message portion identifying the plurality of RSRPs.
Aspect 5: The method of any of Aspects 1 to 4, wherein the msgA includes a preamble conveying information identifying an SSB index, of the plurality of SSB indices, having a strongest RSRP of the plurality of RSRPs, and wherein the msgA includes a shared channel message portion identifying one or more additional SSB indices, of the plurality of SSB indices, or one or more additional RSRPs, of the plurality of RSRPs.
Aspect 6: The method of any of Aspects 1 to 5, wherein the UE is configured to determine a transmit beam based at least in part on an SSB index, of the plurality of SSB indices, with a strongest RSRP of the plurality of RSRPs.
Aspect 7: The method of any of Aspects 1 to 6, wherein the msgB includes a field for receiving an SSB index included in the plurality of SSB indices of the msgA or an SSB index not included in the plurality of SSB indices of the msgA.
Aspect 8: The method of Aspect 7, wherein a downlink quasi-co-location (QCL) parameter is based at least in part on at least one of a value of the SSB index of the field of the msgB or whether the SSB index is included in the plurality of SSB indices of the msgA or not included in the plurality of SSB indices of the msgA.
Aspect 9: The method of any of Aspects 1 to 8, wherein a downlink quasi-co-location (QCL) parameter is based at least in part on a random access response uplink grant medium access control protocol data unit format.
Aspect 10: The method of any of Aspects 1 to 9, wherein a downlink quasi-co-location (QCL) parameter is based at least in part on a random access radio network temporary identifier associated with the msgA.
Aspect 11: The method of any of Aspects 1 to 10, wherein the response message includes at least one of: a first SSB index that is different from a second SSB index included in the msgB, or an RSRP value for the first SSB index.
Aspect 12: The method of any of Aspects 1 to 11, wherein the UE is configured to use a downlink or uplink quasi-co-location parameter associated with an SSB index included in the response message.
Aspect 13: The method of any of Aspects 1 to 12, wherein the response message is constrained to include an SSB index, that is different from another SSB index of the msgB, with a strongest RSRP of the plurality of RSRPs.
Aspect 14: The method of any of Aspects 1 to 13, further comprising: receiving a system information block including random access channel configuration information, wherein the random access channel configuration information identifies at least one of: preamble resources for a subset of SSB indices of a set of configured SSB indices, preamble resources for the set of configured SSB indices, preamble and shared channel resources for the subset of SSB indices, or preamble and shared channel resources for the set of configured SSB indices.
Aspect 15: The method of any of Aspects 1 to 14, wherein the UE is configured to include information relating to the plurality of SSB indices or the plurality of RSRPs in a channel state information report configuration with a report quantity.
Aspect 16: The method of Aspect 15, wherein the UE is configured based at least in part on a system information block, system information, or a static configuration.
Aspect 17: A method of wireless communication performed by a base station, comprising: receiving a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs; transmitting a message type-B (msgB) in the two-step RACH procedure, identifying a downlink beam associated with an SSB based at least in part on receiving the msgA; and receiving a response message, based at least in part on transmitting the msgB, indicating a confirmation of an SSB index identified in the msgB or indicating a reversion to a different SSB index.
Aspect 18: The method of Aspect 17, wherein the msgA includes one or more fields for reporting the plurality of SSB indices.
Aspect 19: The method of any of Aspects 17 to 18, wherein the msgA is based at least in part on a random access channel occasion or a random access channel preamble partitioning.
Aspect 20: The method of any of Aspects 17 to 19, wherein the msgA includes a preamble conveying information identifying the plurality of SSB indices, and wherein the msgA includes a shared channel message portion identifying the plurality of RSRPs.
Aspect 21: The method of any of Aspects 17 to 20, wherein the msgA includes a preamble conveying information identifying an SSB index, of the plurality of SSB indices, having a strongest RSRP of the plurality of RSRPs, and wherein the msgA includes a shared channel message portion identifying one or more additional SSB indices, of the plurality of SSB indices, or one or more additional RSRPs, of the plurality of RSRPs.
Aspect 22: The method of any of Aspects 17 to 21, wherein a transmit beam is based at least in part on an SSB index, of the plurality of SSB indices, with a strongest RSRP of the plurality of RSRPs.
Aspect 23: The method of any of Aspects 17 to 22, wherein the msgB includes a field for receiving an SSB index included in the plurality of SSB indices of the msgA or an SSB index not included in the plurality of SSB indices of the msgA.
Aspect 24: The method of Aspect 23, wherein a downlink quasi-co-location (QCL) parameter is based at least in part on at least one of a value of the SSB index of the field of the msgB or whether the SSB index is included in the plurality of SSB indices of the msgA or not included in the plurality of SSB indices of the msgA.
Aspect 25: The method of any of Aspects 17 to 24, wherein a downlink quasi-co-location (QCL) parameter is based at least in part on a random access response uplink grant medium access control protocol data unit format.
Aspect 26: The method of any of Aspects 17 to 25, wherein a downlink quasi-co-location (QCL) parameter is based at least in part on a random access radio network temporary identifier associated with the msgA.
Aspect 27: The method of any of Aspects 17 to 26, wherein the response message includes at least one of: a first SSB index that is different from a second SSB index included in the msgB, or an RSRP value for the first SSB index.
Aspect 28: The method of any of Aspects 17 to 27, wherein the response message includes a downlink or uplink quasi-co-location parameter associated with an SSB index.
Aspect 29: The method of any of Aspects 17 to 28, wherein the response message is constrained to include an SSB index, that is different from another SSB index of the msgB, with a strongest RSRP of the plurality of RSRPs.
Aspect 30: The method of any of Aspects 17 to 29, further comprising: transmitting a system information block including random access channel configuration information, wherein the random access channel configuration information identifies at least one of: preamble resources for a subset of SSB indices of a set of configured SSB indices, preamble resources for the set of configured SSB indices, preamble and shared channel resources for the subset of SSB indices, or preamble and shared channel resources for the set of configured SSB indices.
Aspect 31: The method of any of Aspects 17 to 30, wherein information relating to the plurality of SSB indices or the plurality of RSRPs is included in a channel state information report configuration with a report quantity.
Aspect 32: The method of Aspect 31, wherein the base station is configured to configure a user equipment using a system information block or system information.
Aspect 33: An apparatus for wireless communication at a device, comprising a processor; memory coupled with the processor; and instructions stored in the memory and executable by the processor to cause the apparatus to perform the method of one or more of Aspects 1-16.
Aspect 34: A device for wireless communication, comprising a memory and one or more processors coupled to the memory, the one or more processors configured to perform the method of one or more of Aspects 1-16.
Aspect 35: An apparatus for wireless communication, comprising at least one means for performing the method of one or more of Aspects 1-16.
Aspect 36: A non-transitory computer-readable medium storing code for wireless communication, the code comprising instructions executable by a processor to perform the method of one or more of Aspects 1-16.
Aspect 37: A non-transitory computer-readable medium storing a set of instructions for wireless communication, the set of instructions comprising one or more instructions that, when executed by one or more processors of a device, cause the device to perform the method of one or more of Aspects 1-16.
Aspect 38: An apparatus for wireless communication at a device, comprising a processor; memory coupled with the processor; and instructions stored in the memory and executable by the processor to cause the apparatus to perform the method of one or more of Aspects 17-32.
Aspect 39: A device for wireless communication, comprising a memory and one or more processors coupled to the memory, the one or more processors configured to perform the method of one or more of Aspects 17-32.
Aspect 40: An apparatus for wireless communication, comprising at least one means for performing the method of one or more of Aspects 17-32.
Aspect 41: A non-transitory computer-readable medium storing code for wireless communication, the code comprising instructions executable by a processor to perform the method of one or more of Aspects 17-32.
Aspect 42: A non-transitory computer-readable medium storing a set of instructions for wireless communication, the set of instructions comprising one or more instructions that, when executed by one or more processors of a device, cause the device to perform the method of one or more of Aspects 17-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a +b, a +c, b+c, and a +b+c, as well as any combination with multiples of the same element (e.g., a +a, a +a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs;
receive a message type-B (msgB) in the two-step RACH procedure, identifying a downlink beam associated with an SSB based at least in part on transmitting the msgA; and
transmit a response message, based at least in part on receiving the msgB, indicating a confirmation of an SSB index identified in the msgB or indicating a reversion to a different SSB index.

2. The UE of claim 1, wherein the msgA includes one or more fields for reporting the plurality of SSB indices.

3. The UE of claim 1, wherein the msgA is based at least in part on a random access channel occasion or a random access channel preamble partitioning.

4. The UE of claim 1, wherein the msgA includes a preamble conveying information identifying the plurality of SSB indices, and
wherein the msgA includes a shared channel message portion identifying the plurality of RSRPs.

5. The UE of claim 1, wherein the msgA includes a preamble conveying information identifying an SSB index, of the plurality of SSB indices, having a strongest RSRP of the plurality of RSRPs, and
wherein the msgA includes a shared channel message portion identifying one or more additional SSB indices, of the plurality of SSB indices, or one or more additional RSRPs, of the plurality of RSRPs.

6. The UE of claim 1, wherein the UE is configured to determine a transmit beam based at least in part on an SSB index, of the plurality of SSB indices, with a strongest RSRP of the plurality of RSRPs.

7. The UE of claim 1, wherein the msgB includes a field for receiving an SSB index included in the plurality of SSB indices of the msgA or an SSB index not included in the plurality of SSB indices of the msgA.

8. The UE of claim 7, wherein a downlink quasi-co-location (QCL) parameter is based at least in part on at least one of a value of the SSB index of the field of the msgB or whether the SSB index is included in the plurality of SSB indices of the msgA or not included in the plurality of SSB indices of the msgA.

9. The UE of claim 1, wherein a downlink quasi-co-location (QCL) parameter is based at least in part on a random access response uplink grant medium access control protocol data unit format.

10. The UE of claim 1, wherein a downlink quasi-co-location (QCL) parameter is based at least in part on a random access radio network temporary identifier associated with the msgA.

11. The UE of claim 1, wherein the response message includes at least one of:
a first SSB index that is different from a second SSB index included in the msgB, or
an RSRP value for the first SSB index.

12. The UE of claim 1, wherein the UE is configured to use a downlink or uplink quasi-co-location parameter associated with an SSB index included in the response message.

13. The UE of claim 1, wherein the response message is constrained to include an SSB index, that is different from another SSB index of the msgB, with a strongest RSRP of the plurality of RSRPs.

14. The UE of claim 1, wherein the one or more processors are further configured to:
receiving a system information block including random access channel configuration information, wherein the random access channel configuration information identifies at least one of:
preamble resources for a subset of SSB indices of a set of configured SSB indices,
preamble resources for the set of configured SSB indices,
preamble and shared channel resources for the subset of SSB indices, or
preamble and shared channel resources for the set of configured SSB indices.

15. The UE of claim 1, wherein the UE is configured to include information relating to the plurality of SSB indices or the plurality of RSRPs in a channel state information report configuration with a report quantity.

16. The UE of claim 15, wherein the UE is configured based at least in part on a system information block, system information, or a static configuration.

17. A base station for wireless communication, comprising:
a memory; and
one or more processors, coupled to the memory, configured to:
receive a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs;
transmit a message type-B (msgB) in the two-step RACH procedure, identifying a downlink beam associated with an SSB based at least in part on receiving the msgA; and
receive a response message, based at least in part on transmitting the msgB, indicating a confirmation of an SSB index identified in the msgB or indicating a reversion to a different SSB index.

18. The base station of claim 17, wherein the msgA includes one or more fields for reporting the plurality of SSB indices.

19. The base station of claim 17, wherein the msgA is based at least in part on a random access channel occasion or a random access channel preamble partitioning.

20. The base station of claim 17, wherein the msgA includes a preamble conveying information identifying the plurality of SSB indices, and
wherein the msgA includes a shared channel message portion identifying the plurality of RSRPs.

21. The base station of claim 17, wherein the msgA includes a preamble conveying information identifying an SSB index, of the plurality of SSB indices, having a strongest RSRP of the plurality of RSRPs, and
wherein the msgA includes a shared channel message portion identifying one or more additional SSB indices, of the plurality of SSB indices, or one or more additional RSRPs, of the plurality of RSRPs.

22. The base station of claim 17, wherein a transmit beam is based at least in part on an SSB index, of the plurality of SSB indices, with a strongest RSRP of the plurality of RSRPs.

23. The base station of claim 17, wherein the msgB includes a field for receiving an SSB index included in the plurality of SSB indices of the msgA or an SSB index not included in the plurality of SSB indices of the msgA.

24. The base station of claim 23, wherein a downlink quasi-co-location (QCL) parameter is based at least in part on at least one of a value of the SSB index of the field of the msgB or whether the SSB index is included in the plurality of SSB indices of the msgA or not included in the plurality of SSB indices of the msgA.

25. The base station of claim 17, wherein a downlink quasi-co-location (QCL) parameter is based at least in part on a random access response uplink grant medium access control protocol data unit format.

26. The base station of claim 17, wherein a downlink quasi-co-location (QCL) parameter is based at least in part on a random access radio network temporary identifier associated with the msgA.

27. The base station of claim 17, wherein the response message includes at least one of:
a first SSB index that is different from a second SSB index included in the msgB, or
an RSRP value for the first SSB index.

28. The base station of claim 17, wherein the response message includes a downlink or uplink quasi-co-location parameter associated with an SSB index.

29. A method of wireless communication performed by a user equipment (UE), comprising:
transmitting a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs;
receiving a message type-B (msgB) in the two-step RACH procedure, identifying a downlink beam associated with an SSB based at least in part on transmitting the msgA; and
transmitting a response message, based at least in part on receiving the msgB, indicating a confirmation of an SSB index identified in the msgB or indicating a reversion to a different SSB index.

30. A method of wireless communication performed by a base station, comprising:
receiving a message type-A (msgA), of a two-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) associated with the plurality of SSBs;
transmitting a message type-B (msgB) in the two-step RACH procedure, identifying a downlink beam associated with an SSB based at least in part on receiving the msgA; and
receiving a response message, based at least in part on transmitting the msgB, indicating a confirmation of an SSB index identified in the msgB or indicating a reversion to a different SSB index.
